(19) United States
(12) Patent Application Publication
(10) Pub. No.: US 2026/0200787 A1
(43) Pub. Date: Jul. 16, 2026

(54) APPARATUS OF MANUFACTURING OPTICAL FIBER AND METHOD OF MANUFACTURING OPTICAL FIBER

(71) Applicant: SUMITOMO ELECTRIC INDUSTRIES, LTD., Osaka (JP)

(72) Inventors: Tatsuro HASEGAWA, Osaka (JP); Iwao OKAZAKI, Osaka (JP)

(21) Appl. No.: 19/416,142

(22) Filed: Dec. 11, 2025

(30) Foreign Application Priority Data
Jan. 10, 2025 (JP) 2025-004127

(51) Int. Cl. C03B 37/029; C03B 37/025; C03B 37/027; C03B 37/03

(52) U.S. Cl. CPC C03B 37/029; C03B 37/0253; C03B 37/02736; C03B 37/032; C03B 2205/40

(57) ABSTRACT

In an apparatus of manufacturing an optical fiber according to the present disclosure, on a path line from a capstan that takes up the optical fiber to the bobbin provided downstream of the capstan, a guide roller that guides the optical fiber, a dancer roller unit that applies a tension to the optical fiber, and a tension measuring unit that measures the tension of the optical fiber are provided, and only the dancer roller unit is a roller unit having a drive source . The guide roller is rotatably mounted on a fixed shaft attached to a fixed wall. The dancer roller unit includes a dancer roller around which the optical fiber winds, and a tension adjusting mechanism that adjusts the tension to be applied to the optical fiber by the dancer roller.

### CROSS REFERENCE TO RELATED APPLICATIONS

This application claims priority based on Japanese Patent Application No. 2025-004127 filed on January 10, 2025, and the entire contents of the Japanese patent application are incorporated herein by reference.

### TECHNICAL FIELD

The present disclosure relates to an apparatus of manufacturing an optical fiber and a method of manufacturing an optical fiber.

### BACKGROUND

Conventionally, as an apparatus of manufacturing an optical fiber in which an optical fiber drawn from a drawing furnace for heating and softening a glass preform and coated with a resin is wound onto a bobbin, there is known an apparatus of manufacturing an optical fiber including a screening device for applying a screening tension to the optical fiber and measuring the tension of the optical fiber in a screening step, and a dancer roller device for adjusting the tension of the optical fiber, on a path line from a capstan for taking up the optical fiber to the bobbin provided downstream of the capstan (for example, see Patent Literature 1: Japanese Unexamined Patent Application Publication No. 2020-084989 (particularly, see FIG. 1)).

### SUMMARY

An apparatus of manufacturing an optical fiber according to the present disclosure is an apparatus of manufacturing an optical fiber. The appratus is configured to wind the optical fiber onto a bobbin. The optical fiber is drawn from a drawing furnace configured to heat and soften a glass preform, and is coated with a resin. On a path line from a capstan configured to take up the optical fiber to the bobbin provided downstream of the capstan, a guide roller configured to guide the optical fiber, a dancer roller unit configured to apply a tension to the optical fiber, and a tension measuring unit configured to measure the tension of the optical fiber are provided, and only the dancer roller unit is a roller unit having a drive source. The guide roller is rotatably mounted on a fixed shaft attached to a fixed wall. The dancer roller unit includes a dancer roller around which the optical fiber winds, and a tension adjusting mechanism configured to adjust the tension to be applied to the optical fiber by the dancer roller. Driving of at least one of a bobbin motor configured to rotate the bobbin and the tension adjusting mechanism is controlled by a tension control device based on the tension applied to the optical fiber and measured by the tension measuring unit, and the tension to be applied to the optical fiber becomes a predetermined tension.

A method of manufacturing an optical fiber according to the present disclosure is a method of manufacturing an optical fiber performed by an apparatus of manufacturing an optical fiber. The apparatus is configured to wind the optical fiber onto a bobbin. The optical fiber is drawn from a drawing furnace configured to heat and soften a glass preform and is coated with a resin. On a path line from a capstan configured to take up the optical fiber to the bobbin provided downstream of the capstan, a guide roller configured to guide the optical fiber, a dancer roller unit configured to apply a tension to the optical fiber, and a tension measuring unit configured to measure the tension of the optical fiber are provided, and only the dancer roller unit is a roller unit having a drive source. The guide roller is rotatably mounted on a fixed shaft attached to a fixed wall. The dancer roller unit includes a dancer roller around which the optical fiber winds, and a tension adjusting mechanism configured to adjust the tension to be applied to the optical fiber by the dancer roller. Driving of at least one of a bobbin motor configured to rotate the bobbin and the tension adjusting mechanism is controlled by a tension control device, the tension to be applied to the optical fiber becomes a predetermined tension. The method includes measuring the tension applied to the optical fiber by the tension measuring unit, and adjusting a tension to be applied to the optical fiber by controlling driving of at least one of the bobbin motor and the tension adjusting mechanism by the tension control device based on the tension applied to the optical fiber and measured by the tension measuring unit.

### BRIEF DESCRIPTION OF THE DRAWINGS

FIG. 1 is a schematic view of an apparatus of manufacturing an optical fiber according to a first embodiment of the present disclosure.

FIG. 2 is a side view of an example of an installation state of a guide roller shown in FIG. 1.

FIG. 3 is a side view of an example of a dancer roller unit shown in FIG. 1.

FIG. 4 is a schematic view of an apparatus of manufacturing an optical fiber according to a second embodiment of the present disclosure.

FIG. 5 is a side view of an example of a dancer roller unit shown in FIG. 4.

### DETAILED DESCRIPTION

In the apparatus of manufacturing the optical fiber described in the Patent Literature 1, since two devices, i.e., the screening device and the dancer roller device are provided on the path line from the capstan to the bobbin, the apparatus of manufacturing the optical fiber is complicated.

The present disclosure is intended to solve the problems associated with the prior art as described above, and an object of the present disclosure is to simplify an apparatus configuration of an apparatus of manufacturing an optical fiber in a path line from a capstan to a bobbin.

### Description of Embodiments of Present Disclosure

The contents of the embodiments of the present disclosure will be listed and described first. (1) An apparatus of manufacturing an optical fiber according to the present disclosure is an apparatus of manufacturing an optical fiber. The appratus is configured to wind the optical fiber onto a bobbin. The optical fiber is drawn from a drawing furnace configured to heat and soften a glass preform and is coated with a resin. On a path line from a capstan configured to take up the optical fiber to the bobbin provided downstream of the capstan, a guide roller configured to guide the optical fiber, a dancer roller unit configured to apply a tension to the optical fiber, and a tension measuring unit configured to measure the tension of the optical fiber are provided, and only the dancer roller unit is a roller unit having a drive source . The guide roller is rotatably mounted on a fixed shaft attached to a fixed wall. The dancer roller unit includes a dancer roller around which the optical fiber winds, and a tension adjusting mechanism configured to adjust the tension to be applied to the optical fiber by the dancer roller. Driving of at least one of a bobbin motor configured to rotate the bobbin and the tension adjusting mechanism is controlled by a tension control device based on the tension applied to the optical fiber and measured by the tension measuring unit, and the tension to be applied to the optical fiber becomes a predetermined tension. As described above, since on the path line from the capstan configured to take up the optical fiber to the bobbin provided downstream of the capstan, the guide roller configured to guide the optical fiber, the dancer roller unit configured to apply the tension to the optical fiber, and the tension measuring unit configured to measure the tension of the optical fiber are provided, and only the dancer roller unit is a roller unit having a drive source, the guide roller is rotatably mounted on the fixed shaft attached to the fixed wall, and the dancer roller unit includes the dancer roller around which the optical fiber winds and the tension adjusting mechanism configured to adjust the tension to be applied to the optical fiber by the dancer roller, the roller unit having a drive source on the path line from the capstan to the bobbin is only the dancer roller unit, and thus motors conventionally required for driving a screening roller and a tension help roller are not required, and an apparatus configuration of the apparatus of manufacturing the optical fiber in the path line from the capstan to the bobbin can be simplified. Furthermore, driving of at least one of the bobbin motor configured to rotate the bobbin and the tension adjusting mechanism is controlled by the tension control device based on the tension applied to the optical fiber and measured by the tension measuring unit, and the tension of the optical fiber becomes the predetermined tension, so that the tension control device only needs to control driving of at least one of the bobbin motor and the tension adjusting mechanism to adjust the tension of the optical fiber to the predetermined tension, and thus, the tension to be applied to the optical fiber can be changed even during the drawing.

In the above apparatus of manufacturing the optical fiber, a bobbin switching device may be provided and configured to switch a winding destination of the optical fiber drawn from the drawing furnace to one of the bobbin onto which the optical fiber is wound while a screening inspection is performed and the bobbin onto which the optical fiber is wound after the screening inspection is ended. The tension control device may set a winding tension to be applied to the optical fiber after the screening inspection is ended to a tension smaller than a screening tension to be applied to the optical fiber in the screening inspection. As described above, the tension control device sets the winding tension to be applied to the optical fiber after the screening inspection is ended to a tension smaller than the screening tension to be applied to the optical fiber in the screening inspection, so that the tension to be applied to the optical fiber is changed without stopping the drawing of the optical fiber when the screening inspection is ended, and thus the manufacturing efficiency of the optical fiber can be improved.

A "screening inspection" herein means "an inspection of whether or not the optical fiber is broken by applying a certain tension to the optical fiber".

In the above apparatus of manufacturing the optical fiber, the tension adjusting mechanism of the dancer roller unit may be an air cylinder configured to apply a thrust in an up-direction or a down-direction orthogonal to an axial direction of a rotation shaft of the dancer roller to the dancer roller. Thus, a movable direction of the dancer roller is one of the up-direction and the down-direction, and an installation layout of the tension adjusting mechanism is space-saved, so that the apparatus of manufacturing the optical fiber can be easily downsized.

In the above apparatus of manufacturing the optical fiber, the tension adjusting mechanism of the dancer roller unit may include a torque applying motor including a drive shaft extending in substantially parallel to a rotation shaft of the dancer roller and an encoder configured to detect a rotation position of the drive shaft, and may include an arm member having one end coupled to the rotation shaft of the dancer roller and another end coupled to the drive shaft of the torque applying motor. Thus, when the torque applying motor is rotated, torque is applied to the dancer roller via the arm member, and thus, the position of the dancer roller can be easily estimated from the encoder of the torque applying motor, and the position of the dancer roller can be detected at low cost.

A method of manufacturing an optical fiber according to the present disclosure is a method of manufacturing an optical fiber performed by an apparatus of manufacturing an optical fiber. The apparatus is configured to wind the optical fiber onto a bobbin. The optical fiber is drawn from a drawing furnace configured to heat and soften a glass preform and is coated with a resin. On a path line from a capstan configured to take up the optical fiber to the bobbin provided downstream of the capstan, a guide roller configured to guide the optical fiber, a dancer roller unit configured to apply a tension to the optical fiber, and a tension measuring unit configured to measure the tension of the optical fiber are provided, and only the dancer roller unit is a roller unit having a drive source. The guide roller is rotatably mounted on a fixed shaft attached to a fixed wall. The dancer roller unit includes a dancer roller around which the optical fiber winds, and a tension adjusting mechanism configured to adjust the tension to be applied to the optical fiber by the dancer roller. Driving of at least one of a bobbin motor configured to rotate the bobbin and the tension adjusting mechanism is controlled by a tension control device, the tension to be applied to the optical fiber becomes a predetermined tension. The method includes measuring the tension applied to the optical fiber by the tension measuring unit, and adjusting a tension to be applied to the optical fiber by controlling driving of at least one of the bobbin motor and the tension adjusting mechanism by the tension control device based on the tension applied to the optical fiber and measured by the tension measuring unit. As described above, since on the path line from the capstan configured to take up the optical fiber to the bobbin provided downstream of the capstan, the guide roller configured to guide the optical fiber, the dancer roller unit configured to apply a tension to the optical fiber, and the tension measuring unit configured to measure the tension of the optical fiber are provided, and only the dancer roller unit is a roller unit having a drive source, the guide roller is rotatably mounted on the fixed shaft attached to the fixed wall, and the dancer roller unit includes the dancer roller around which the optical fiber winds, and the tension adjusting mechanism configured to adjust the tension to be applied to the optical fiber by the dancer roller, the roller unit having a drive source on the path line from the capstan to the bobbin is only the dancer roller unit, and thus, motors conventionally required for driving the screening roller and the tension help roller are not required, and the apparatus configuration of the apparatus of manufacturing the optical fiber in the path line from the capstan to the bobbin can be simplified. Furthermore, the method includes adjusting a tension to be applied to the optical fiber by controlling driving of at least one of the bobbin motor and the tension adjusting mechanism by the tension control device based on the tension applied to the optical fiber and measured by the tension measuring unit, so that the tension control device only needs to control driving of at least one of the bobbin motor and the tension adjusting mechanism to adjust the tension of the optical fiber to the predetermined tension, and thus, the tension to be applied to the optical fiber can be changed even during the drawing.

In the method of manufacturing the optical fiber, the apparatus of manufacturing the optical fiber further includes a bobbin switching device configured to switch a winding destination of the optical fiber drawn from the drawing furnace to one of the bobbin onto which the optical fiber is wound while a screening inspection is performed and the bobbin onto which the optical fiber is wound after the screening inspection is ended. The method further includes switching the winding destination of the optical fiber drawn from the bobbin onto which the optical fiber is wound while the screening inspection is performed to the bobbin onto which the optical fiber is wound after the screening inspection is ended, and setting a winding tension to be applied to the optical fiber after the screening inspection is ended to a tension smaller than a screening tension to be applied to the optical fiber while the screening inspection is performed. As described above, the method further includes switching the winding destination of the optical fiber drawn from the bobbin onto which the optical fiber is wound while the screening inspection is performed to the bobbin onto which the optical fiber is wound after the screening inspection is ended, and setting the winding tension to be applied to the optical fiber after the screening inspection is ended to a tension smaller than the screening tension to be applied to the optical fiber while the screening inspection is performed, so that the tension to be applied to the optical fiber is changed without stopping the drawing of the optical fiber when the screening inspection is ended, and thus the manufacturing efficiency of the optical fiber can be improved.

### Details of Embodiments of Present Disclosure

Hereinafter, specific examples of an apparatus of manufacturing an optical fiber and a method of manufacturing an optical fiber according to the present disclosure will be described.

### First Embodiment of Apparatus of Manufacturing Optical Fiber

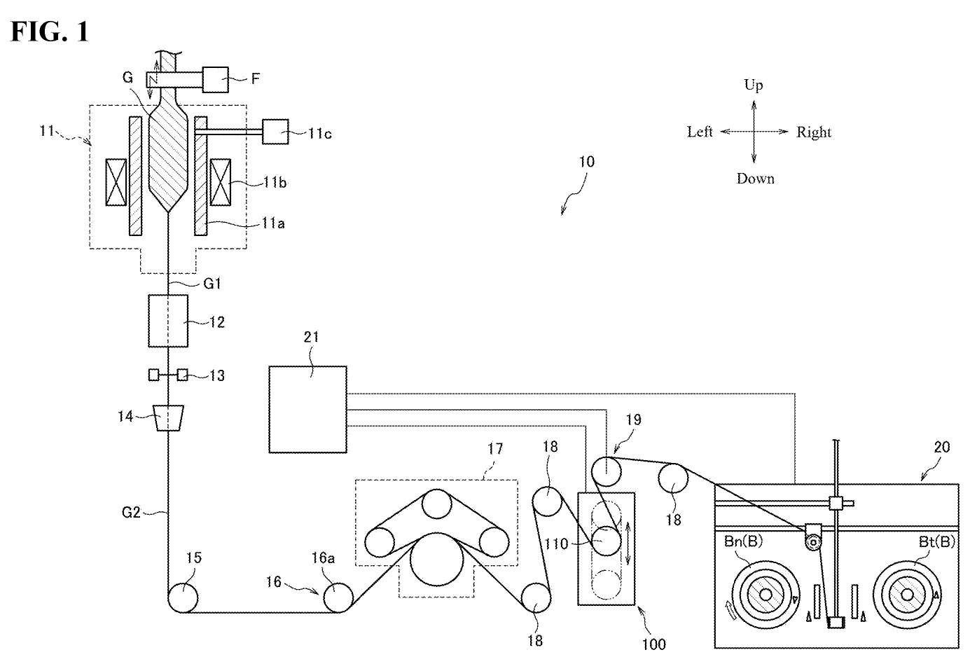

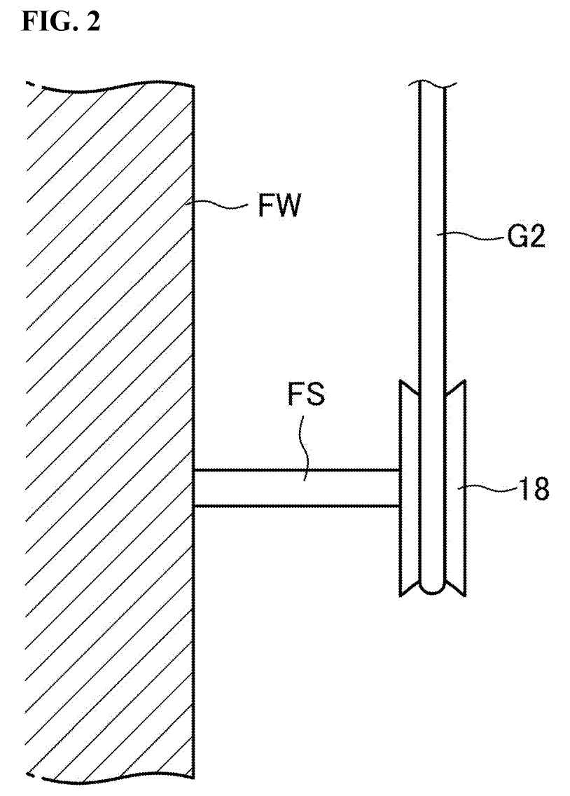

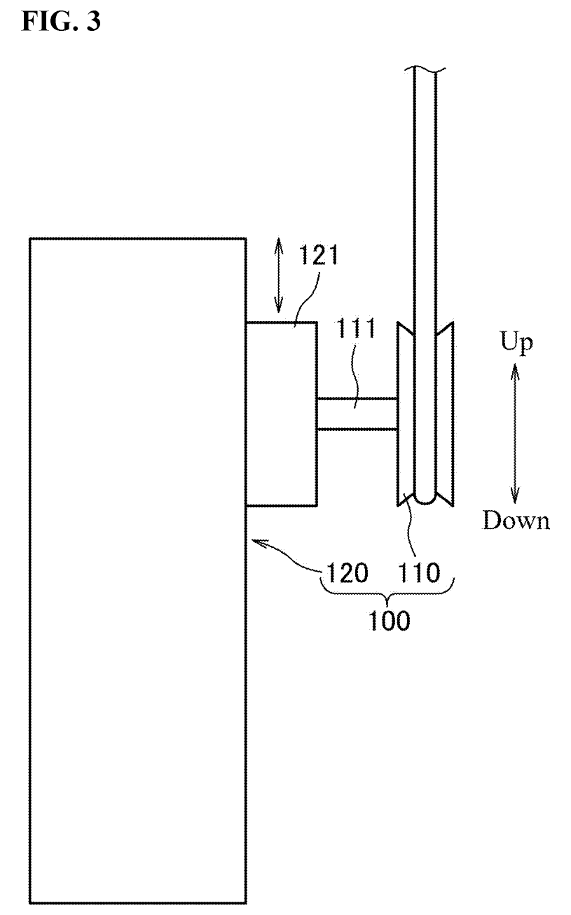

First, a first embodiment of an apparatus of manufacturing an optical fiber according to the present disclosure will be described with reference to FIGS. 1 to 3. FIG. 1 is a schematic view of an apparatus of manufacturing an optical fiber according to the first embodiment of the present disclosure, FIG. 2 is a side view of an example of an installation state of a guide roller shown in FIG. 1, and FIG. 3 is a side view of an example of a dancer roller unit shown in FIG. 1.

As shown in FIG. 1, an optical fiber manufacturing apparatus (an apparatus of manufacturing an optical fiber) 10 includes a drawing furnace 11 for heating and softening a glass preform G for an optical fiber at a most upstream position.

The drawing furnace 11 includes a cylindrical furnace tube 11a to an inner side of which the glass preform G is supplied, a heating element 11b surrounding the furnace tube 11a, and a gas supply unit 11c supplying a purge gas to the furnace tube 11a. An upper portion of the glass preform G is held by a preform feeding unit F, and the glass preform G is fed into the furnace tube 11a by using the preform feeding unit F. In the drawing furnace 11 configured as described above, when a lower end portion of the glass preform G is heated by the heating element 11b and drawn downward, a glass fiber G1 serving as a center portion of an optical fiber G2 is formed.

The optical fiber manufacturing apparatus 10 includes a cooling unit 12 downstream of the drawing furnace 11. The glass fiber G1 drawn downward from the drawing furnace 11 is cooled by the cooling unit 12.

A cooling gas such as a helium gas is supplied to the cooling unit 12. The cooling unit 12 may be a cooling system using a cooling gas other than the helium gas, as long as the glass fiber G1 can be cooled in a non-contact manner.

The optical fiber manufacturing apparatus 10 includes an outer diameter measuring unit 13 downstream of the cooling unit 12. The outer diameter of the glass fiber G1 cooled by the cooling unit 12 is measured by the outer diameter measuring unit 13 and then the glass fiber G1 is fed downward.

The outer diameter measuring unit 13 is implemented to be able to measure the outer diameter of the glass fiber G1 using, for example, a laser beam. The outer diameter measuring unit 13 may be implemented by a system other than the laser system as long as the outer diameter of the glass fiber G1 can be measured in a non-contact manner.

The optical fiber manufacturing apparatus 10 includes a coating unit 14 downstream of the outer diameter measuring unit 13. For example, a urethane acrylate resin, which is an ultraviolet curable resin, is applied to the glass fiber G1 whose outer diameter is measured by the outer diameter measuring unit 13. When the urethane acrylate resin is irradiated with ultraviolet light and cured, the optical fiber G2, in which the periphery of the glass fiber G1 is coated with the resin, is formed.

The optical fiber manufacturing apparatus 10 includes a direct lower roller 15 downstream of the coating unit 14. A traveling direction of the optical fiber G2 passed through the coating unit 14 is changed by the direct lower roller 15.

The direct lower roller 15 is disposed directly below the drawing furnace 11 and guides the optical fiber G2 drawn out from the drawing furnace 11 and traveling along a vertical direction. The direct lower roller 15 is provided with a groove of a predetermined shape such as a fiber traveling groove having a V-shaped cross section, and the optical fiber G2 comes into contact with an inner wall surface of the groove and the optical fiber G2 is guided.

The optical fiber manufacturing apparatus 10 includes a lead roller 16 downstream of the direct lower roller 15. The traveling direction of the optical fiber G2 passed through the direct lower roller 15 is changed by the lead roller 16.

The lead roller 16 is also provided with a groove of a predetermined shape such as a fiber running groove having a V-shaped cross section, and the optical fiber G2 comes into contact with an inner wall surface of the groove and the optical fiber G2 is guided.

The optical fiber manufacturing apparatus 10 includes a capstan 17 for taking up the optical fiber G2 passed through the lead roller 16.

The optical fiber manufacturing apparatus 10 includes a plurality of (two in the embodiment) guide rollers 18 downstream of the capstan 17. The traveling direction of the optical fiber G2 passed through the capstan 17 is changed by the guide roller 18.

As shown in FIG. 2, the guide roller 18 is rotatably mounted on a fixed shaft FS attached to a fixed wall FW. The guide roller 18 is also provided with a groove of a predetermined shape such as a fiber traveling groove having a V-shaped cross section, and the optical fiber G2 comes into contact with an inner wall surface of the groove and the optical fiber G2 is guided.

The optical fiber manufacturing apparatus 10 includes a dancer roller unit 100 downstream of the guide roller 18. The optical fiber G2 passed through the guide roller 18 is given tension by the dancer roller unit 100 and sent downstream.

As shown in FIG. 3, the dancer roller unit 100 includes a dancer roller 110 around which the optical fiber G2 winds, and an air cylinder 120 as a tension adjusting mechanism for adjusting the tension to be applied to the optical fiber G2 by the dancer roller 110.

A movable portion 121 of the air cylinder 120 is coupled to a rotation shaft 111 of the dancer roller 110, allowing the dancer roller 110 to move freely in an up-direction or a down-direction (directions orthogonal to an axial direction of the rotation shaft 111 of the dancer roller 110). That is, the air cylinder 120 applies a thrust in the up-direction or the down-direction to the dancer roller 110.

The optical fiber manufacturing apparatus 10 includes a tension measuring unit 19 for measuring the tension of the optical fiber G2 downstream of the dancer roller unit 100. The tension of the optical fiber G2 passed through the dancer roller unit 100 is measured by the tension measuring unit 19.

The optical fiber manufacturing apparatus 10 further includes the guide roller 18 downstream of the tension measuring unit 19. The traveling direction of the optical fiber G2 passed through the tension measuring unit 19 is changed by the guide roller 18.

The optical fiber manufacturing apparatus 10 includes a bobbin switching device 20 to which a plurality of (two in the embodiment) bobbins B are attached downstream of the guide roller 18. Thus, the optical fiber G2 drawn from the drawing furnace 11 and coated with resin is wound onto the bobbins B.

The bobbin switching device 20 is a device that switches a winding destination of the optical fiber G2 to one of the bobbin B (inspection bobbin Bt) onto which the optical fiber G2 is wound while a screening inspection is performed and the bobbin B (normal operation bobbin Bn) onto which the optical fiber G2 is wound after the screening inspection is ended, and is provided with bobbin motors (not shown) that rotate the inspection bobbin Bt and the normal operation bobbin Bn, respectively.

The optical fiber manufacturing apparatus 10 further includes a tension control device 21 electrically connected to the dancer roller unit 100, the tension measuring unit 19, and the bobbin switching device 20, and controls driving of the air cylinder 120 and the bobbin motors of the bobbin switching device 20 based on the tension measurement result of the tension measuring unit 19.

According to the optical fiber manufacturing apparatus 10 configured as described above, since on the path line from the capstan 17 that take up the optical fiber G2 to the bobbin B provided downstream of the capstan 17, the guide rollers 18 that guide the optical fiber G2, the dancer roller unit 100 that applies a tension to the optical fiber G2, and the tension measuring unit 19 that measures the tension of the optical fiber G2 are provided, and only the dancer roller unit 100 is a roller unit having a drive source, each guide roller 18 is rotatably mounted on the fixed shaft FS attached to the fixed wall FW, and the dancer roller unit 100 includes the dancer roller 110 around which the optical fiber G2 winds and the air cylinder 120 that is the tension adjusting mechanism that adjusts the tension to be applied to the optical fiber by the dancer roller 110, the roller unit having a drive source on the path line from the capstan 17 to the bobbin B is only the dancer roller unit 100. Thus motors conventionally required for driving the screening roller and the tension help roller are not required, and the apparatus configuration of the optical fiber manufacturing apparatus on the path line from the capstan 17 to the bobbin B can be simplified. Further, driving of the air cylinder 120 is controlled by the tension control device 21 based on the tension applied to the optical fiber G2 and measured by the tension measuring unit 19, and the tension of the optical fiber G2 becomes a predetermined tension, so that the tension control device 21 only needs to control driving of the air cylinders 120 to adjust the tension of the optical fiber G2 to the predetermined tension, and thus, the tension to be applied to the optical fiber G2 can be changed even during drawing.

Further, the tension control device 21 sets the winding tension to be applied to the optical fiber G2 to a tension smaller than the tension to be applied to the optical fiber G2 in the screening inspection after the screening inspection is ended, so that the tension to be applied to the optical fiber is changed without stopping the drawing of the optical fiber G2 when the screening inspection is ended, and thus the manufacturing efficiency of the optical fiber G2 can be improved.

In addition, since the tension adjusting mechanism of the dancer roller unit 100 is the air cylinder 120 that applies the thrust to the dancer roller 110 in the up-direction or the down-direction orthogonal to the axial direction of the rotation shaft 111 of the dancer roller 110, a movable direction of the dancer roller 110 is one of the up-direction and the down-direction, and the installation layout of the tension adjusting mechanism is space-saved, so that the optical fiber manufacturing apparatus 10 can be easily downsized.

### Method of Manufacturing Optical Fiber by First Embodiment of Optical Fiber Manufacturing Apparatus

Next, a method of manufacturing an optical fiber using the optical fiber manufacturing apparatus 10 will be described.

The method of manufacturing an optical fiber using the optical fiber manufacturing apparatus 10 described above is mainly divided into two steps, i.e., (1) a screening step and (2) a normal operation step.

Screening Step In the screening step, the tension control device 21 drives the bobbin motor of the bobbin switching device 20 to wind the optical fiber G2 onto the inspection bobbin Bt. At this time, in the screening step, a tension measuring step is performed in which the tension measuring unit 19 measures a screening tension applied to the optical fiber G2 in a state in which the tension control device 21 controls the driving of the air cylinder 120 to apply a predetermined tension to the optical fiber G2.

As a result of performing the tension measuring step, when the tension applied to the optical fiber G2 is higher than a predetermined screening tension, it is determined that no quality defect occurs in the optical fiber G2, and the screening step is ended.

### Normal Operation Step

In the normal operation step, first, a bobbin switching step is performed in which the winding destination of the optical fiber G2 is switched from the inspection bobbin Bt to the normal operation bobbin Bn, and the winding tension to be applied to the optical fiber G2 is set to a tension smaller than the screening tension applied to the optical fiber G2 in the screening step (when the optical fiber G2 is wound onto the inspection bobbin Bt). Then, the tension control device 21 drives the bobbin motor of the bobbin switching device 20 to wind the optical fiber G2 onto the normal operation bobbin Bn.

At this time, a tension adjustment step is performed in which the tension control device 21 controls the driving of the air cylinder 120 based on the tension applied to the optical fiber G2 at the time of winding measured by the tension measuring unit 19 so as to adjust the tension to be applied to the optical fiber G2.

According to the method of manufacturing the optical fiber configured as described above, the method includes the tension adjustment step in which the tension control device 21 controls the driving of the air cylinder 120 based on the tension applied to the optical fiber G2 and measured by the tension measuring unit 19, so that the tension control device 21 only needs to control driving of the air cylinder 120 to adjust the tension of the optical fiber to the predetermined tension, and thus, the tension to be applied to the optical fiber G2 can be changed even during drawing.

Further, the method further includes the bobbin switching step of switching the winding destination of the optical fiber G2 from the inspection bobbin Bt onto which the optical fiber G2 is wound while the screening inspection is performed to the normal operation bobbin Bn onto which the optical fiber G2 is wound after the screening inspection is ended, and setting the winding tension to be applied to the optical fiber G2 after the screening inspection is ended to a tension smaller than the tension applied to the optical fiber G2 during the screening inspection, so that the tension to be applied to the optical fiber G2 is changed without stopping the drawing of the optical fiber G2 when the screening inspection is ended, and thus the manufacturing efficiency of the optical fiber G2 can be improved.

### Second Embodiment of Apparatus of Manufacturing Optical Fiber

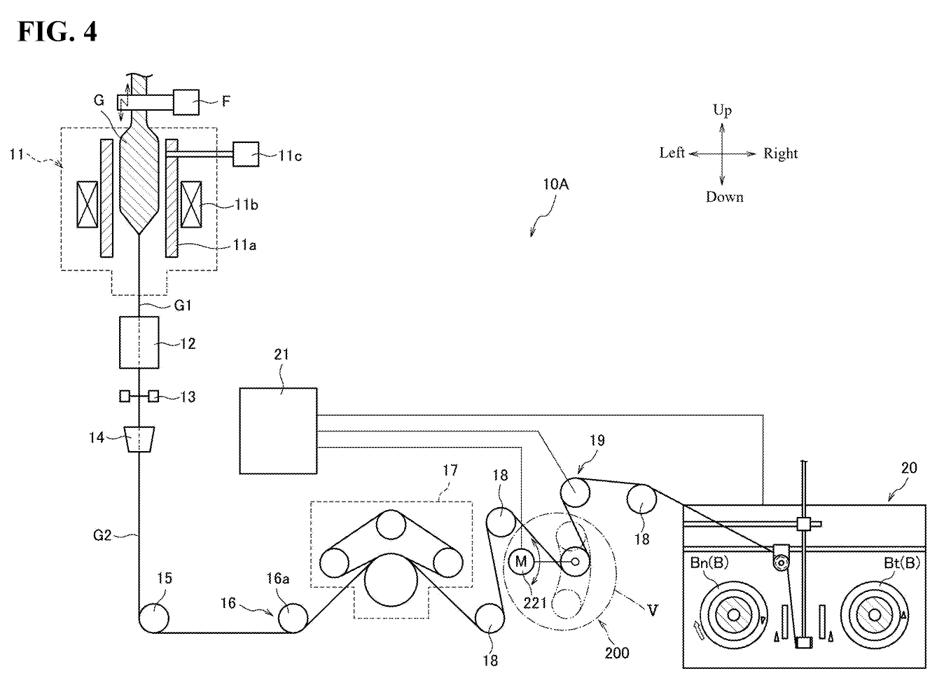

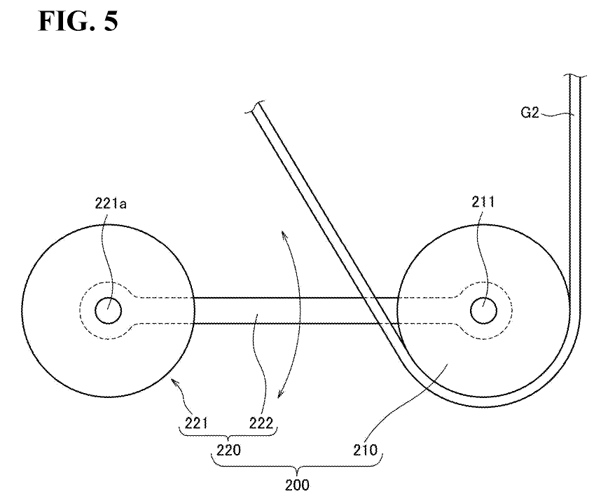

Next, a second embodiment of the apparatus of manufacturing the optical fiber used in the method of manufacturing of the optical fiber according to the present disclosure will be described with reference to FIGS. 4 and 5. FIG. 4 is a schematic view of an apparatus of manufacturing an optical fiber according to the second embodiment of the present disclosure, and FIG. 5 is a side view of an example of a dancer roller unit shown in FIG. 4. An optical fiber manufacturing apparatus (optical fiber manufacturing apparatus) 10A of the second embodiment is obtained by changing the dancer roller unit in the optical fiber manufacturing apparatus 10 of the first embodiment, and many elements are common to the optical fiber manufacturing apparatus 10 of the first embodiment, and thus, detailed description of common matters will be omitted.

As shown in FIG. 5, a dancer roller unit 200 in the second embodiment includes a dancer roller 210 around which the optical fiber G2 winds, and a tension adjusting mechanism 220 for adjusting the tension to be applied to the optical fiber G2 by the dancer roller 210. The tension adjusting mechanism 220 includes a torque applying motor (for example, a servo motor) 221 having a drive shaft 221a extending in substantially parallel to a rotation shaft 211 of the dancer roller 210 and an encoder (not shown) for detecting a rotation position of the drive shaft 221a, and an arm member 222 having one end coupled to the rotation shaft 211 of the dancer roller 210 and another end coupled to the drive shaft 221a of the torque applying motor 221.

In the optical fiber manufacturing apparatus 10A described above, the tension control device 21 is electrically connected to the dancer roller unit 200, the tension measuring unit 19, and the bobbin switching device 20, and controls driving of the torque applying motor 221 and the bobbin motor of the bobbin switching device 20 based on the tension measurement result of the tension measuring unit 19.

According to the optical fiber manufacturing apparatus 10A configured as described above, since the tension adjusting mechanism of the dancer roller unit 200 includes the torque applying motor 221 having the drive shaft 221a extending in substantially parallel to the rotation shaft 211 of the dancer roller 210, and the arm member 222 having one end coupled to the rotation shaft 211 of the dancer roller 210 and another end coupled to the drive shaft 221a of the torque applying motor 221, when the torque applying motor 221 is rotated, torque is applied to the dancer roller 210 via the arm member 222, and thus, the position of the dancer roller 210 can be easily estimated from the encoder of the torque applying motor 221, and the position of the dancer roller 210 can be detected at low cost.

### Method of Manufacturing Optical Fiber by Second Embodiment of Optical Fiber Manufacturing Apparatus

Next, a method of manufacturing an optical fiber using the optical fiber manufacturing apparatus 10A will be described.

### Screening Step

In the tension measuring step of the screening step, the tension measuring unit 19 measures the tension applied to the optical fiber G2 in a state in which the tension control device 21 controls driving of the torque applying motor 221 to apply a predetermined screening tension to the optical fiber G2.

As a result of performing the tension measuring step, when the tension applied to the optical fiber G2 is higher than a predetermined screening tension, it is determined that no quality defect occurs in the optical fiber G2, and the screening step is ended.

### Normal Operation Step

In the normal operation step, first, a bobbin switching step is performed in which the winding destination of the optical fiber G2 is switched from the inspection bobbin Bt to the normal operation bobbin Bn, and the winding tension to be applied to the optical fiber G2 is set to a tension smaller than the screening tension applied to the optical fiber G2 in the screening step (when the optical fiber G2 is wound onto the inspection bobbin Bt). Then, the tension control device 21 drives the bobbin motor of the bobbin switching device 20 to wind the optical fiber G2 onto the normal operation bobbin Bn.

At this time, the tension control device 21 controls the driving of the torque applying motor 221 based on the tension applied to the optical fiber G2 at the time of winding measured by the tension measuring unit 19, and a tension adjustment step of adjusting the tension to be applied to the optical fiber G2 is performed.

### Modification

Although the embodiments of the present disclosure have been described above, the present disclosure is not limited to the above embodiments. In addition, the respective elements included in the above-described embodiments can be combined as long as it is technically possible, and the combination thereof is also included in the scope of the present disclosure as long as it includes the features of the present disclosure.

For example, in the first embodiment, the tension control device 21 controls the driving of the air cylinder 120 to adjust the tension to be applied to the optical fiber G2, but the tension control device 21 may control the driving of only the bobbin motor or may control the driving of both the bobbin motor and the air cylinder 120 in order to adjust the tension to be applied to the optical fiber G2. Similarly, in the second embodiment, the tension control device 21 controls the driving of the torque applying motor 221 to adjust the tension to be applied to the optical fiber G2, but the tension control device 21 may control the driving of only the bobbin motor or may control the driving of both the bobbin motor and the torque applying motor 221 to adjust the tension to be applied to the optical fiber G2.

What is claimed is:

1. An apparatus of manufacturing an optical fiber, the apparatus being configured to wind the optical fiber onto a bobbin, the optical fiber being drawn from a drawing furnace configured to heat and soften a glass preform and being coated with a resin,
wherein, on a path line from a capstan configured to take up the optical fiber to the bobbin provided downstream of the capstan, a guide roller configured to guide the optical fiber, a dancer roller unit configured to apply a tension to the optical fiber, and a tension measuring unit configured to measure the tension of the optical fiber are provided, and only the dancer roller unit is a roller unit having a drive source,
wherein the guide roller is rotatably mounted on a fixed shaft attached to a fixed wall,
wherein the dancer roller unit includes a dancer roller around which the optical fiber winds, and a tension adjusting mechanism configured to adjust the tension to be applied to the optical fiber by the dancer roller, and
wherein driving of at least one of a bobbin motor configured to rotate the bobbin and the tension adjusting mechanism is controlled by a tension control device based on the tension applied to the optical fiber and measured by the tension measuring unit, and the tension to be applied to the optical fiber becomes a predetermined tension.

2. The apparatus of manufacturing the optical fiber according to claim 1,
wherein a bobbin switching device is provided and configured to switch a winding destination of the optical fiber drawn from the drawing furnace to one of the bobbin onto which the optical fiber is wound while a screening inspection is performed and the bobbin onto which the optical fiber is wound after the screening inspection is ended, and
wherein the tension control device sets a winding tension to be applied to the optical fiber after the screening inspection is ended to a tension smaller than a screening tension to be applied to the optical fiber in the screening inspection.

3. The apparatus of manufacturing the optical fiber according to claim 1,
wherein the tension adjusting mechanism of the dancer roller unit is an air cylinder configured to apply a thrust in an up-direction or a down-direction orthogonal to an axial direction of a rotation shaft of the dancer roller to the dancer roller.

4. The apparatus of manufacturing the optical fiber according to claim 1,
wherein the tension adjusting mechanism of the dancer roller unit includes a torque applying motor including a drive shaft extending in substantially parallel to a rotation shaft of the dancer roller and an encoder configured to detect a rotation position of the drive shaft, and includes an arm member having one end coupled to the rotation shaft of the dancer roller and another end coupled to the drive shaft of the torque applying motor.

5. A method of manufacturing an optical fiber performed by an apparatus of manufacturing an optical fiber, the apparatus being configured to wind the optical fiber onto a bobbin, the optical fiber being drawn from a drawing furnace configured to heat and soften a glass preform and being coated with a resin; on a path line from a capstan configured to take up the optical fiber to the bobbin provided downstream of the capstan, a guide roller configured to guide the optical fiber, a dancer roller unit configured to apply a tension to the optical fiber, and a tension measuring unit configured to measure the tension of the optical fiber being provided and only the dancer roller unit is a roller unit having a drive source; the guide roller being rotatably mounted on a fixed shaft attached to a fixed wall; the dancer roller unit including a dancer roller around which the optical fiber winds, and a tension adjusting mechanism configured to adjust the tension to be applied to the optical fiber by the dancer roller; driving of at least one of a bobbin motor configured to rotate the bobbin and the tension adjusting mechanism being controlled by a tension control device, the tension to be applied to the optical fiber becoming a predetermined tension, the method comprising:
measuring the tension applied to the optical fiber by the tension measuring unit; and
adjusting a tension to be applied to the optical fiber by controlling driving of at least one of the bobbin motor and the tension adjusting mechanism by the tension control device based on the tension applied to the optical fiber and measured by the tension measuring unit.

6. The method of manufacturing the optical fiber according to claim 5,
wherein the apparatus of manufacturing the optical fiber further includes a bobbin switching device configured to switch a winding destination of the optical fiber drawn from the drawing furnace to one of the bobbin onto which the optical fiber is wound while a screening inspection is performed and the bobbin onto which the optical fiber is wound after the screening inspection is ended, and
wherein the method further comprises switching the winding destination of the optical fiber drawn from the bobbin onto which the optical fiber is wound while the screening inspection is performed to the bobbin onto which the optical fiber is wound after the screening inspection is ended, and setting a winding tension to be applied to the optical fiber after the screening inspection is ended to a tension smaller than a screening tension to be applied to the optical fiber while the screening inspection is performed.
